(19) United States
(12) Patent Application Publication
(10) Pub. No.: US 2026/0073152 A1
(43) Pub. Date: Mar. 12, 2026

(54) METHOD, APPARATUS, DEVICE, AND STORAGE MEDIUM FOR TRAINING MODEL

(71) Applicant: Lemon Inc., Grand Cayman (KY)

(72) Inventors: Yu WANG, Culver City, CA (US); Qingqing Huang, Los Angeles, CA (US); Xueying Zhang, Los Angeles, CA (US); Shizhu Liu, Los Angeles, CA (US); Jitong Chen, Los Angeles, CA (US)

(21) Appl. No.: 19/319,275

(22) Filed: Sep. 4, 2025

(30) Foreign Application Priority Data
Sep. 6, 2024 (CN) 202411253706.9

(51) Int. Cl. G06F 40/35; G06F 40/58

(52) U.S. Cl. CPC G06F 40/35; G06F 40/58

(57) ABSTRACT

A method, an apparatus, a device, and a storage medium for training a model are provided. The method includes: constructing a set of candidate lyrics content based on reference lyrics content, each candidate lyrics content including at least one paragraph in the reference lyrics content; determining target lyrics content satisfying a predetermined requirement from the set of candidate lyrics content based on evaluation information of the set of candidate lyrics content; generating description information corresponding to the target lyrics content, the description information indicating a plurality of attributes of the target lyrics content; constructing a set of prompts corresponding to the target lyrics content based on the description information; and training a lyrics generation model based on the set of prompts and the target lyrics content.

### CROSS REFERENCE

This application claims priority to Chinese Application No. 202411253706.9, filed on Sep. 6, 2024 and entitled “METHOD, APPARATUS, DEVICE, AND STORAGE MEDIUM FOR TRAINING MODEL”, the entirety of which is incorporated herein by reference.

### FIELD

Example embodiments of the present disclosure generally relate to the field of computers, and in particular, to a method, an apparatus, a device and a computer-readable storage medium for training a model.

### BACKGROUND

With the development of Internet and computer technologies, natural language processing has been developed. In the field of natural language processing, lyrics generation models have been widely concerned and used. Therefore, the generation effect of the lyrics generation model has become a major public concern.

### SUMMARY

In a first aspect of the present disclosure, a method for training a model is provided. The method includes: constructing a set of candidate lyrics content based on reference lyrics content, each candidate lyrics content including at least one paragraph in the reference lyrics content; determining target lyrics content satisfying a predetermined requirement from the set of candidate lyrics content based on evaluation information of the set of candidate lyrics content; generating description information corresponding to the target lyrics content, the description information indicating a plurality of attributes of the target lyrics content; constructing a set of prompts corresponding to the target lyrics content based on the description information; and training a lyrics generation model based on the set of prompts and the target lyrics content.

In a second aspect of the present disclosure, an apparatus for training a model is provided. The apparatus includes a first construction module, a lyrics determination module, an information generation module, a second construction module, and a model training module. The first construction module is configured to construct a set of candidate lyrics content based on reference lyrics content, and each candidate lyrics content includes at least one paragraph in the reference lyrics content. The lyrics determination module is configured to determine target lyrics content satisfying a predetermined requirement from the set of candidate lyrics content based on evaluation information of the set of candidate lyrics content. The information generation module is configured to generate description information corresponding to the target lyrics content, and the description information indicates a plurality of attributes of the target lyrics content. The second construction module is configured to construct a set of prompts corresponding to the target lyrics content based on the description information. The model training module is configured to train a lyrics generation model based on the set of prompts and the target lyrics content.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements. In the drawings:

FIG. 1 illustrates a schematic diagram of an example environment in which embodiments according to the present disclosure may be implemented;

FIG. 2 illustrates a flowchart of a process of training a model according to some embodiments of the present disclosure;

FIG. 3 illustrates a schematic diagram of an example for training a model according to some embodiments of the present disclosure;

FIG. 4 illustrates a schematic structural block diagram of an example apparatus for training a model according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout, and any type of embodiment may be included in any section/subsection. Furthermore, the embodiments described in any section/subsection may be combined in any manner with any other embodiment described in the same section/subsection and/or different sections/subsections.

In the description of the embodiments of the present disclosure, the terms “including” and the like should be understood to mean an open-ended inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all data collection, acquisition, treatment, processing, forwarding, use and the like are performed on the premise that the user knows and confirms. Accordingly, when implementing the embodiments of the present disclosure, the type, the usage scope, the usage scenario, and the like of the data or information that may be involved should be notified to the user and obtain the authorization from the user in an appropriate manner according to the relevant laws and regulations. The specific notification and/or authorization manner may vary according to actual situations and application scenarios, and the scope of the disclosure is not limited in this regard.

According to the solutions in the present specification and the embodiments, for example, personal information processing is involved, processing may be performed on the premise of having a legal basis (for example, obtaining consent of a personal information subject, or necessary for performing a fulfillment contract), and processing may be performed only within a specified or agreed range. In the case that the user refuses personal information other than necessary information required by the basic function, the use of the basic function by the user will not be affected.

The data (including but not limited to the data itself, the acquisition and/or use of the data) involved in the solution provided by the present specification and embodiments, as related to the training and inference of the model, follow the requirements of the corresponding laws and regulations.

According to a conventional solution, on one hand, the lyrics generation task is based on a lyrics generation model obtained by training with reference to a common copywriting, and a condition of multiple dimensions of lyrics cannot be satisfied. On the other hand, the electronic device only relies on the lyrics data itself to train, and the height adaptability of the downstream song generating task cannot be achieved.

Embodiments of the present disclosure provide a solution for training a model. According to the solution, a set of candidate lyrics content may be constructed based on reference lyrics content, and each candidate lyrics content includes at least one paragraph in the reference lyrics content; target lyrics content satisfying a predetermined requirement is determined from the set of candidate lyrics content based on evaluation information of the set of candidate lyrics content; description information corresponding to the target lyrics content is generated, and the description information indicates a plurality of attributes of the target lyrics content; a set of prompts corresponding to the target lyrics content are constructed based on the description information; and a lyrics generation model is trained based on the set of prompts and the target lyrics content.

In this way, the embodiments of the present disclosure can construct training data with multi-dimensional attributes (e.g., lyrics themes, song styles, voice information, expression states, and lyrics structures) based on the reference lyrics content, thereby improving the quality of the training data. Further, by training the lyrics generation model with such training data, the embodiments of the present disclosure can improve the quality of lyrics generated by the lyrics generation model and have multi-dimensional attributes related to music, thereby improving the adaptability to the music generation model.

Various example implementations of this solution are described in detail below in conjunction with the accompanying drawings.

### Example Environment

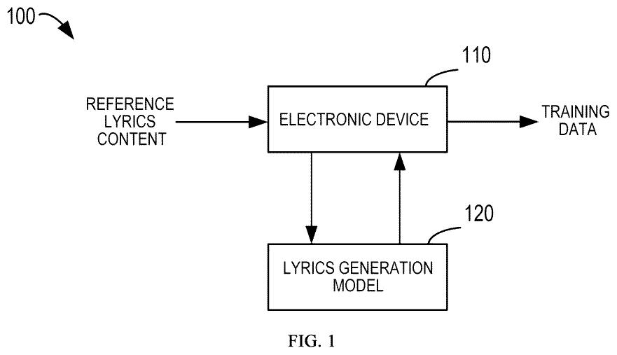

FIG. 1 illustrates a schematic diagram of an example environment 100 in which embodiments of the present disclosure may be implemented. As shown in FIG. 1, the example environment 100 may include an electronic device 110 and a lyrics generation model 120.

In this example environment 100, the electronic device 110 constructs training data based on reference lyrics content to train a lyrics generation model 120. The electronic device 110 is at least configured to construct the received reference lyrics content as a set of candidate lyrics content. Further, the electronic device 110 determines target lyrics content and a corresponding set of prompts based on the set of candidate lyrics content. The electronic device 110 trains the lyrics generation model 120 based on the target lyrics content and the set of prompts.

As an example, the lyrics generation model 120 may be, for example, a transformer-based language model.

In some embodiments, the electronic device 110 may establish a communication connection with the lyrics generation model 120. That is, the electronic device 110 may invoke a local or remote lyrics generation model 120.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

It should be understood that the structures and functions of various elements in the environment 100 are described for illustrative purposes only and do not imply any limitation to the scope of the present disclosure.

### Example Process

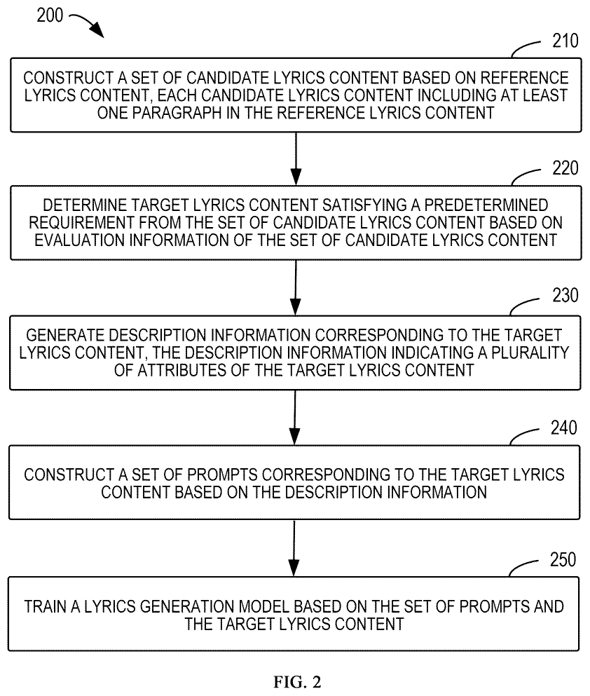

FIG. 2 illustrates a flowchart of an example process 200 of training a model according to some embodiments of the present disclosure. The process 200 may be implemented at the electronic device 110. The process 200 is described below with reference to FIG. 1.

In some embodiments, the electronic device 110 may obtain reference music content, and further, the electronic device 110 may identify the reference music content as corresponding reference audio content and the reference lyrics content based on a pre-trained model.

As shown in FIG. 2, at block 210, the electronic device 110 constructs a set of candidate lyrics content based on the reference lyrics content, and each candidate lyrics content includes at least one paragraph in the reference lyrics content.

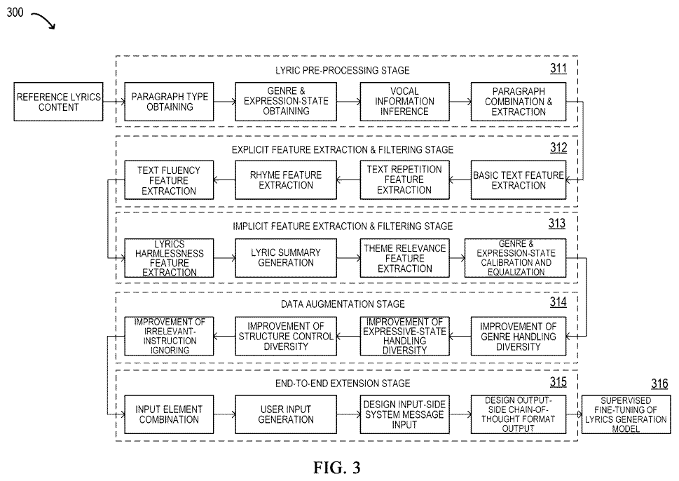

In some embodiments, the reference lyrics content may be, for example, lyrics content of any language. Referring to FIG. 3, at block 311, the electronic device 110 may perform a pre-processing operation on the reference lyrics content.

In some embodiments, the electronic device 110 may determine a plurality of paragraphs of the reference lyrics content. As an example, the electronic device 110 may process the reference music content with an audio processing model (for example, a Deep Chorus model) to divide a paragraph type of the reference lyrics content corresponding to the reference music content. As an example, the paragraph type may include, for example, verse, chorus, and other paragraph types.

In some embodiments, the electronic device 110 may identify a genre and an expression state in the reference audio content with a pre-trained model (e.g., a tagging model). The genre may include, for example, pop, Guofeng, rock, and the like. Further, the electronic device 110 may further infer voice information in the reference audio content by using a language model.

Further, the electronic device 110 may construct a plurality of paragraph combinations of the plurality of paragraphs obtained above to obtain a set of candidate lyrics content.

As an example, the electronic device 110 may retain a verse part and a chorus part of the reference lyrics content and randomly combine the corresponding plurality of paragraphs to obtain a set of candidate lyrics content. In some embodiments, such a set of candidate lyrics content corresponds to a predetermined length of time. The predetermined length may, for example, range from 30 seconds to 90 seconds, to fit the demands on generation of one-minute lyrics.

In some other embodiments, the electronic device 110 may not perform paragraph division on the reference lyrics content, and directly serve the reference lyrics content (for example, the complete lyrics content) as the candidate lyrics content.

Referring back to FIG. 2, at block 220, the electronic device 110 determines target lyrics content satisfying a preset requirement from a set of candidate lyrics content based on evaluation information of the set of candidate lyrics content.

For ease of description, such a set of candidate lyrics content is described below as a first set of lyrics content. In some embodiments, the evaluation information may be, for example, text repetition information, rhyming evaluation information, text fluency information, and the like.

In some embodiments, referring to FIG. 3, at block 312, the electronic device 110 may filter the candidate lyrics content, that does not satisfy the expectation or does not match the ideal situation, from the first set of candidate lyrics content by using a basic text feature extraction model, to optimize the overall data quality.

Further, the electronic device 110 may further remove at least one candidate lyrics content from the first set of candidate lyrics content based on the evaluation information, to determine a second set of candidate lyrics content.

In some embodiments, the electronic device 110 may remove, based on a text repetition rate indicated by the evaluation information, first candidate lyrics content having the text repetition rate higher than a first threshold from the first set of candidate lyrics content. As an example, the electronic device 110 may filter data whose text repetition rate is too high in the first set of candidate lyrics content, to remove the first candidate lyrics content whose text repetition rate is higher than the first threshold, thereby avoiding a repetitive example in which the model overfitting is too strong.

In some other embodiments, the electronic device 110 may remove, based on a rhyming evaluation indicated by the evaluation information, second candidate lyrics content having the rhyming evaluation lower than a second threshold from the first set of candidate lyrics content. As an example, the electronic device 110 may extract a rhyme feature (for example, a pinyin of an end-of-line character and a rhyme category) in the first set of candidate lyrics content, and calculate a rhyme score for a lyrics segment. Further, the electronic device 110 may remove the second candidate lyrics content whose rhyming evaluation is lower than the second threshold, and retain the candidate lyrics content whose rhyming effect is obvious.

In some other embodiments, the electronic device 110 may remove, based on a text fluency indicated by the evaluation information, third candidate lyrics content having the text fluency lower than a third threshold from the first set of candidate lyrics content. As an example, the electronic device 110 may extract a text fluency feature from the first set of candidate lyrics content, and calculate a perplexity as a text fluency index by using a language model. Further, the electronic device 110 may remove third candidate lyrics content whose text fluency index is lower than the third threshold, and retain candidate lyrics content having a fluency satisfying the predetermined requirement.

In this way, the electronic device 110 may determine the second set of candidate lyrics content based on the text repetition rate, the rhyming evaluation, and a relationship between the text fluency and the threshold in the first set of candidate lyrics content.

In some embodiments, the electronic device 110 may determine the target lyrics content from the second set of candidate lyrics content obtained above.

Referring to FIG. 3, at block 313, the electronic device 110 may generate a theme description text of the second set of candidate lyrics content. As an example, the electronic device 110 may score a harmlessness feature of the second set of candidate lyrics content by using a language model, and remove the candidate lyrics content including harmfulness content. Further, the electronic device 110 may further generate, by a pre-trained theme generation model, a lyrics summary with the second set of candidate lyrics content including the harmful ness content removed, to obtain a theme description text of the second set of candidate lyrics content.

In some embodiments, in a generation stage of a lyrics summary, it is required to generate a segment of lyrics summary for each candidate lyrics content of the second set of candidate lyrics content, to simulate a possible user input in the real scenario. In some embodiments, the electronic device 110 may generate theme data of each candidate lyrics content in a prompt engineering manner by using a language model. In some embodiments, each candidate lyrics content generates a segment of “story” theme, that is, a short story containing more characters; and then generate a segment of “keyword” theme, that is, a brief keyword. In this way, the electronic device 110 may cover as broad a range of theme input form as possible. Further, the electronic device 110 may fine filter the part of data to ensure data quality, and train a language model based on the part of high-quality data, for generation of the theme data of the candidate lyrics content. The electronic device 110 may also add control conditions on the input side to enable controllable generation of a “story” theme or a “keyword” theme. Further, the electronic device 110 may generate a “story” theme and a “keyword” theme from a large quantity of candidate lyrics content by using the trained language model, and mix the two themes as a final lyrics summary in a certain proportion, to serve as the theme description text of the second set of candidate lyrics content.

Further, the electronic device 110 may determine the target lyrics content based on a matching degree between the theme description text and the reference lyrics content. As an example, the electronic device 110 may score a relevance between the generated theme description text and the reference lyrics content based on the language model, and remove the data whose theme relevance is too low, thereby determining the target lyrics content.

Further, the electronic device 110 may re-score a genre confidence and an expression state confidence of the target lyrics content based on the language model, re-allocate a genre label and an expression state label based on a scoring result, improve the correlation between the overall genre and the expression state of the target lyrics content, and the coverage degree of the niche category. In this way, the electronic device 110 calibrates and equalizes the genre and expression state of the target lyrics content.

Referring back to FIG. 2, at block 230, the electronic device 110 generates description information corresponding to the target lyrics content, and the description information indicates a plurality of attributes of the target lyrics content.

In some embodiments, the plurality of attributes may include, for example, a lyrics theme, a song style, voice information, an expression state, a lyrics structure, or the like.

In some embodiments, the electronic device 110 may provide reference description content about a predetermined attribute of the target lyrics content to a first model, to generate a set of extended description contents corresponding to the predetermined attribute.

In some embodiments, the predetermined attribute may be, for example, a song style, an expression state, and a lyrics structure.

Referring to FIG. 3, at block 314, the electronic device 110 may provide the reference description content about a song style of the target lyrics content to the first model, to expand the song style of the target lyrics content, increase the mapping capability from any genre to a genre collection, and improve the diversity of the song style.

In some embodiments, the electronic device 110 may further provide the reference description content about an expression state of the target lyrics content to the first model, to expand the expression state of the target lyrics content, increase the mapping capability from any expression state to an expression state collection, and improve the diversity of the expression state.

In some embodiments, the electronic device 110 may further provide the reference description content about a lyrics structure of the target lyrics content to the first model, to expand the lyrics structure of the target lyrics content, increase the structure control capability, and enrich the structure control situation.

In some embodiments, in the diversity improvement stage of the lyrics structure control, the condition of the structure control part instruction under the real user input is simulated, and the first model is trained to behave according to the instruction or the default strategy under different conditions. In some embodiments, the electronic device 110 designs a default strategy for different real instruction situations, including a case where the structure and the number of rows are specified simultaneously, a case where the number of rows is specified separately, a case where the structure is separately specified, or a case in which none of the structure and the number of rows are specified. In some embodiments, the electronic device 110 may also randomly simulate a real instruction situation according to a default strategy, ensure that the training data is sufficiently diverse, and may cover as many real situations as possible. In some embodiments, the electronic device 110 may randomly add structures that need to be ignored, such as an instrumental intro and an accompaniment, to train the ability of the first model to ignore such structures.

In summary, the electronic device 110 may obtain, based on the first model, the song style of the target lyrics, the expression state, and the reference description content corresponding to the lyrics structure, a set of expanded description contents about the target lyrics content.

In this way, the electronic device 110 may generate the description information corresponding to the target lyrics content based on the reference description content and the obtained set of extended description content.

Referring back to FIG. 2, at block 240, the electronic device 110 constructs a set of prompts corresponding to the target lyrics content based on the description information.

In some embodiments, the description information indicates a plurality of attributes of the target lyrics content. Referring to FIG. 3, at block 315, the electronic device 110 may construct a plurality of attribute combinations of the plurality of attributes based on the plurality of attributes as mentioned above. As an example, the electronic device 110 may randomly cover one or more of a lyrics theme, a song style, voice information, an expression status, and a lyrics structure in the plurality of attributes to obtain a plurality of attribute combinations. In this way, the electronic device 110 may simulate a real user input condition to train the ability of the model to automatically complete when the input information is missing.

In some embodiments, the electronic device 110 may provide the plurality of attribute combinations to a second model to generate a set of prompts.

At block 315, the electronic device 110 may polish the obtained set of prompts by using the language model to generate a natural language description to simulate a real user input condition.

Referring back to FIG. 2, at block 250, the electronic device 110 trains a lyrics generation model based on the set of prompts and the target lyrics content.

In some embodiments, the electronic device 110 may design an output format of the lyrics generation model. As an example, the electronic device 110 may splice forms of the lyrics theme, the song style, the expression state, the voice information, the lyrics structure, and the target lyrics content (for example, a format of a chain-of-thought) as an output format of the lyrics generation model.

With continued reference to FIG. 3, at block 316, the electronic device 110 may perform supervised fine-tuning on the lyrics generation model based on the obtained set of prompts and the target lyrics content.

In summary, the electronic device 110 may extend the input part from the basic feature into any form of natural language instruction based on the training mode of the chain-of-thought, the output part firstly performs feature extraction, and then performs lyrics generation, thereby eliminating reliance on the upstream module and realizing the end-to-end lyrics generation model.

In this way, the embodiments of the present disclosure can construct training data with multi-dimensional attributes based on the reference lyrics content, thereby improving the training quality of the lyrics generation model. According to the embodiment of the present disclosure, the lyrics content can be generated based on the fully trained lyrics generation model, and further, the electronic equipment may extract or infer key attributes related to a music to serve them as an input of the music generation model, thereby improving the adaptability of the music generation model.

### Example Apparatus and Device

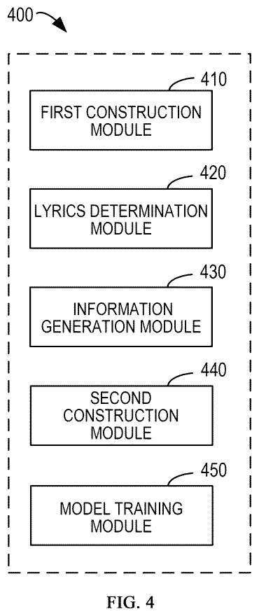

Embodiments of the present disclosure also provide a corresponding apparatus for implementing the above method or process. FIG. 4 illustrates a schematic structural block diagram of an example training model apparatus 400 according to some embodiments of the present disclosure. The apparatus 400 may be implemented or included in the electronic device 110. Various modules/components in the apparatus 400 may be implemented by hardware, software, firmware, or any combination thereof.

As shown in FIG. 4, the apparatus 400 includes a first construction module 410 configured to construct a set of candidate lyrics content based on reference lyrics content, each candidate lyrics content including at least one paragraph in the reference lyrics content; a lyrics determination module 420 configured to determine target lyrics content satisfying a predetermined requirement from the set of candidate lyrics content based on evaluation information of the set of candidate lyrics content; an information generation module 430 configured to generate description information corresponding to the target lyrics content, the description information indicating a plurality of attributes of the target lyrics content; a second construction module 440 configured to construct a set of prompts corresponding to the target lyrics content based on the description information; and a model training module 450 configured to train a lyrics generation model based on the set of prompts and the target lyrics content.

In some embodiments, the first construction module 410 is further configured to determine a plurality of paragraphs of the reference lyrics content; and construct a plurality of paragraph combinations of the plurality of paragraphs to obtain the set of candidate lyrics contents.

In some embodiments, the set of candidate lyrics content is a first set of lyrics content, and the lyrics determination module 420 is further configured to remove at least one piece of candidate lyrics content from the first set of candidate lyrics content based on the evaluation information to determine a second set of candidate lyrics content; and determine the target lyrics content from the second set of candidate lyrics content.

In some embodiments, the lyrics determination module 420 is further configured to perform at least one of the following: removing, based on a text repetition rate indicated by the evaluation information, first candidate lyrics content having the text repetition rate higher than a first threshold from the first set of candidate lyrics content; removing, based on a rhyming evaluation indicated by the evaluation information, second candidate lyrics content having the rhyming evaluation lower than a second threshold from the first set of candidate lyrics content; and removing, based on a text fluency indicated by the evaluation information, third candidate lyrics content having the text fluency lower than a third threshold from the first set of candidate lyrics content.

In some embodiments, the lyrics determination module 420 is further configured to generate a theme description text of the second set of candidate lyrics content; and determine the target lyrics content based on a matching degree between the theme description text and the reference lyrics content.

In some embodiments, the information generation module 430 is further configured to provide reference description content about a predetermined attribute of the target lyrics content to a first model, to generate a set of extended description content corresponding to the predetermined attribute; and generate the description information corresponding to the target lyrics content based on the reference description content and the set of extended description content.

In some embodiments, the plurality of attributes of the target lyrics content indicated by the description information include a plurality of the following: a lyrics topic, a song style, voice information, an expression state, or a lyrics structure.

In some embodiments, the second construction module 440 is further configured to construct a plurality of attribute combinations of the plurality of attributes; and generate the set of prompts based on the plurality of attribute combinations.

In some embodiments, the second construction module 440 is further configured to provide the plurality of attribute combinations to a second model to generate the set of prompts.

In some embodiments, the set of candidate lyrics content corresponds to a predetermined length of time.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

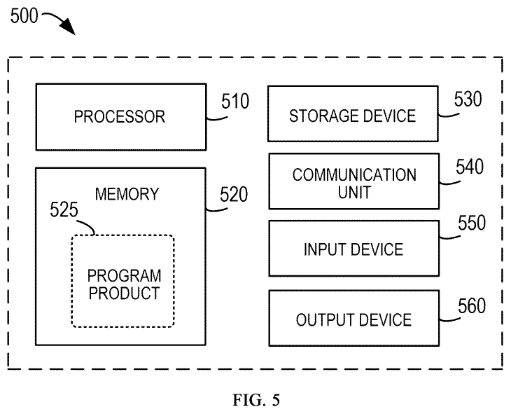

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in a form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units executes computer-executable instructions in parallel to improve the parallel processing capability of the electronic device 500.

The electronic device 500 generally includes a plurality of computer storage media. Such media may be any available media that is accessible by the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic devices through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network profile computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable the user to interact with the electronic device 500, or communicates with any device (e.g., a network card, a modem, etc.) that enables the electronic device 500 to communicate with one or more other electronic devices. Such communication may be executed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions/acts specified in one or more blocks in the flowchart(s) and/or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for training a model, comprising:
constructing a set of candidate lyrics content based on reference lyrics content, each candidate lyrics content comprising at least one paragraph in the reference lyrics content;
determining target lyrics content satisfying a predetermined requirement from the set of candidate lyrics content based on evaluation information of the set of candidate lyrics content;
generating description information corresponding to the target lyrics content, the description information indicating a plurality of attributes of the target lyrics content;
constructing a set of prompts corresponding to the target lyrics content based on the description information; and
training a lyrics generation model based on the set of prompts and the target lyrics content.

2. The method of claim 1, wherein constructing the set of candidate lyrics content based on the reference lyrics content comprises:
determining a plurality of paragraphs of the reference lyrics content; and
constructing a plurality of paragraph combinations of the plurality of paragraphs to obtain the set of candidate lyrics content.

3. The method of claim 1, wherein the set of candidate lyrics content is a first set of lyrics content, and determining the target lyrics content satisfying the predetermined requirement from the set of candidate lyrics content based on the evaluation information of the set of candidate lyrics content comprises:
removing at least one candidate lyrics content from the first set of candidate lyrics content based on the evaluation information to determine a second set of candidate lyrics content; and
determining the target lyrics content from the second set of candidate lyrics content.

4. The method of claim 3, wherein removing the at least one candidate lyrics content from the first set of candidate lyrics content based on the evaluation information to determine the second set of candidate lyrics content comprises at least one of:
removing, based on a text repetition rate indicated by the evaluation information, first candidate lyrics content having the text repetition rate higher than a first threshold from the first set of candidate lyrics content;
removing, based on a rhyming evaluation indicated by the evaluation information, second candidate lyrics content having the rhyming evaluation lower than a second threshold from the first set of candidate lyrics content; or
removing, based on a text fluency indicated by the evaluation information, third candidate lyrics content having the text fluency lower than a third threshold from the first set of candidate lyrics content.

5. The method of claim 3, wherein determining the target lyrics content from the second set of candidate lyrics content comprises:
generating a theme description text of the second set of candidate lyrics content; and
determining the target lyrics content based on a matching degree between the theme description text and the reference lyrics content.

6. The method of claim 1, wherein generating the description information corresponding to the target lyrics content further comprises:
providing reference description content about a predetermined attribute of the target lyrics content to a first model, to generate a set of extended description content corresponding to the predetermined attribute; and
generating the description information corresponding to the target lyrics content based on the reference description content and the set of extended description content.

7. The method of claim 1, wherein the plurality of attributes of the target lyrics content indicated by the description information comprise a plurality of the following:
a lyrics theme, a song style, vocal information, an expression state, or a lyrics structure.

8. The method of claim 1, wherein constructing the set of prompts corresponding to the target lyrics content based on the description information comprises:
constructing a plurality of attribute combinations of the plurality of attributes; and
generating the set of prompts based on the plurality of attribute combinations.

9. The method of claim 8, wherein generating the set of prompts based on the plurality of attribute combinations comprises:
providing the plurality of attribute combinations to a second model to generate the set of prompts.

10. The method of claim 1, wherein the set of candidate lyrics content corresponds to a predetermined length of time.

11. An electronic device, comprising:
at least one processor; and
at least one memory coupled to the at least one processor and storing instructions for execution by the at least one processor, the instructions, when executed by the at least one processor, causing the electronic device to perform acts comprising:
constructing a set of candidate lyrics content based on reference lyrics content, each candidate lyrics content comprising at least one paragraph in the reference lyrics content;
determining target lyrics content satisfying a predetermined requirement from the set of candidate lyrics content based on evaluation information of the set of candidate lyrics content;
generating description information corresponding to the target lyrics content, the description information indicating a plurality of attributes of the target lyrics content;
constructing a set of prompts corresponding to the target lyrics content based on the description information; and
training a lyrics generation model based on the set of prompts and the target lyrics content.

12. The electronic device of claim 11, wherein constructing the set of candidate lyrics content based on the reference lyrics content comprises:
determining a plurality of paragraphs of the reference lyrics content; and
constructing a plurality of paragraph combinations of the plurality of paragraphs to obtain the set of candidate lyrics content.

13. The electronic device of claim 11, wherein the set of candidate lyrics content is a first set of lyrics content, and determining the target lyrics content satisfying the predetermined requirement from the set of candidate lyrics content based on the evaluation information of the set of candidate lyrics content comprises:
removing at least one candidate lyrics content from the first set of candidate lyrics content based on the evaluation information to determine a second set of candidate lyrics content; and
determining the target lyrics content from the second set of candidate lyrics content.

14. The electronic device of claim 13, wherein removing the at least one candidate lyrics content from the first set of candidate lyrics content based on the evaluation information to determine the second set of candidate lyrics content comprises at least one of:
removing, based on a text repetition rate indicated by the evaluation information, first candidate lyrics content having the text repetition rate higher than a first threshold from the first set of candidate lyrics content;
removing, based on a rhyming evaluation indicated by the evaluation information, second candidate lyrics content having the rhyming evaluation lower than a second threshold from the first set of candidate lyrics content; or
removing, based on a text fluency indicated by the evaluation information, third candidate lyrics content having the text fluency lower than a third threshold from the first set of candidate lyrics content.

15. The electronic device of claim 13, wherein determining the target lyrics content from the second set of candidate lyrics content comprises:
generating a theme description text of the second set of candidate lyrics content; and
determining the target lyrics content based on a matching degree between the theme description text and the reference lyrics content.

16. The electronic device of claim 11, wherein generating the description information corresponding to the target lyrics content further comprises:
providing reference description content about a predetermined attribute of the target lyrics content to a first model, to generate a set of extended description content corresponding to the predetermined attribute; and
generating the description information corresponding to the target lyrics content based on the reference description content and the set of extended description content.

17. The electronic device of claim 11, wherein the plurality of attributes of the target lyrics content indicated by the description information comprise a plurality of the following:
a lyrics theme, a song style, vocal information, an expression state, or a lyrics structure.

18. The electronic device of claim 11, wherein constructing the set of prompts corresponding to the target lyrics content based on the description information comprises:
constructing a plurality of attribute combinations of the plurality of attributes; and
generating the set of prompts based on the plurality of attribute combinations.

19. The electronic device of claim 18, wherein generating the set of prompts based on the plurality of attribute combinations comprises:
providing the plurality of attribute combinations to a second model to generate the set of prompts.

20. A non-transitory computer-readable storage medium having a computer program stored thereon, wherein the computer program is executable by a processor to perform acts comprising:
constructing a set of candidate lyrics content based on reference lyrics content, each candidate lyrics content comprising at least one paragraph in the reference lyrics content;
determining target lyrics content satisfying a predetermined requirement from the set of candidate lyrics content based on evaluation information of the set of candidate lyrics content;
generating description information corresponding to the target lyrics content, the description information indicating a plurality of attributes of the target lyrics content;
constructing a set of prompts corresponding to the target lyrics content based on the description information; and
training a lyrics generation model based on the set of prompts and the target lyrics content.
